(19) United States
(12) Patent Application Publication
(10) Pub. No.: US 2013/0018789 A1
(43) Pub. Date: Jan. 17, 2013

(54) Systems and methods for estimating the risk that a real-time promissory payment will default

(71) Applicant: Bernhard Kaufmann, St. Margrethen (CH)

(72) Inventor: Bernhard Kaufmann, St. Margrethen (CH)

(73) Assignee: Payment 21 LLC, Wilmington, DE (US)

(21) Appl. No.: 13/135,723

(22) Filed: Jul. 14, 2011

(51) Int. Cl. G06Q 40/00

(52) U.S. Cl. 705/44

(57) ABSTRACT

Systems and methods are set forth for estimating the risk on-line promissory payment transaction (PPT) will default. A systematic approach is set forth using aspects of human survival behavior under stressful life situations enhanced with transaction velocity settings and parameterized business rules before an actual payment is deposited at a financial institution.

### FIELD OF INVENTION

This invention relates to the detection and prevention of fraud and abusive transactions when using promissory notes.

### BACKGROUND OF THE INVENTION

This invention generally relates to the detection of fraud and abuse transactions when using promissory notes like ACH-checks or check21 items by people under stressful life situations.

These aforementioned methods of payment compete in terms of costs and availability with traditionally well-known methods of payment like credit cards. The processing of promissory notes by the financial institutions managing demand deposit accounts (DDA) involves costs and a defaulted transaction caused by fraudulent behavior should be prevented.

To better identify potentially defaulting transactions one needs to understand the instinctive survival behavior of writers in stressful life situations. This behavior would be shown, for example, when executing a payment anomaly or an attempt to solve short term cash flow requirements related to stressful behavior.

Mechanisms have been developed herein to identify the check-writer and what verifications on the content of the transactions are made before applying a risk mitigation analysis to identify the aforementioned situation. The system is designed to protect merchants against fraud, has been proven effective, and can be integrated as a software program as part of a merchants system (API).

### SUMMARY OF THE INVENTION

The systems and methods set forth herein estimate the risk an Instant eCheck™ payment transaction will default. A systematic approach is formulated using aspects of human survival behavior under stressful life situations enhanced with transaction velocity settings and parameterized business rules before the actual check is requested to be deposited at the bank. Prerequisites and related routines are used to determine validations.

### BRIEF DESCRIPTION OF THE DRAWINGS

FIG. 1 is a diagram that details the verification loop and mitigation system.

FIG. 2 is a diagram that illustrates the real-time check processing system.

FIG. 3 is a diagram that illustrates how PPT are transferred.

FIG. 4 is a graph that illustrates the relationship between promissory payment transactions (PPT) and the risk of default in real-time.

### DESCRIPTION OF THE PREFERRED EMBODIMENT

The best mode and primary embodiment is described herein.

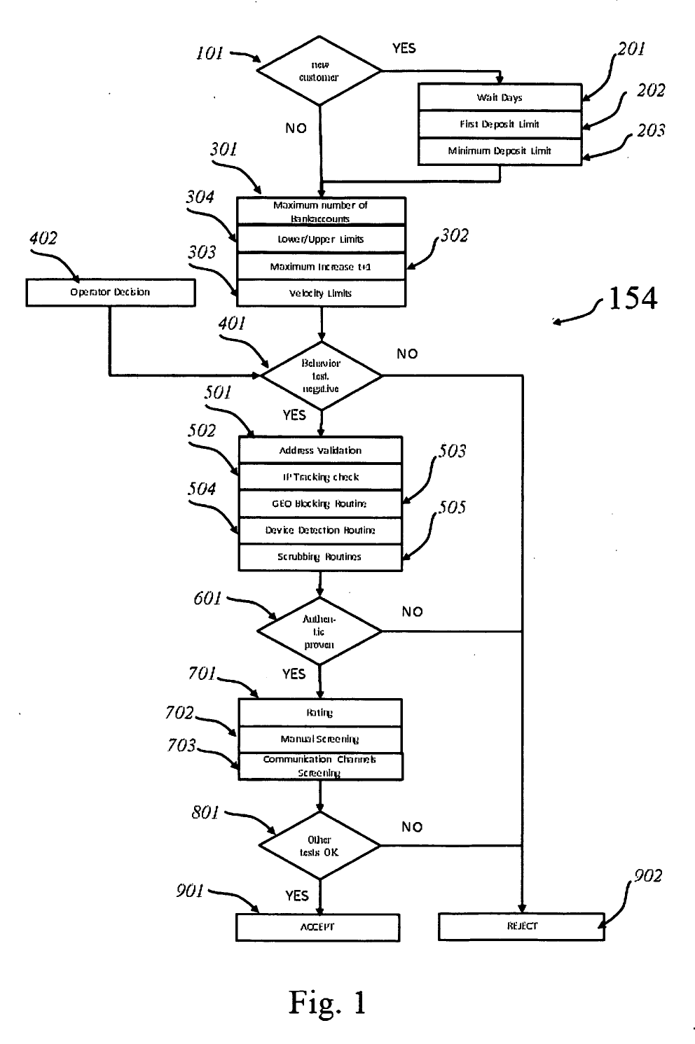

FIG. 1 is a diagram that details verification loop and mitigation system 154. The promissory note (Automatic Clearing House (ACH), Check 21) will undergo a general validation 101 to identify if the writer is new in the system. If the check-writer is new, required wait days 201 will be applied and the first deposit limit 202 and minimum deposit limit 203 applicable to the check-writer in question are set. After the initial clearing 101, a combination of rules are applied to find whether the transaction in question matches behavioral patterns that are indicators of a higher fraud risk. First is identified how many accounts 301 the writer has registered. Limits are set per writer preventing a potential fraud by deploying more than one account 301. Next the system uses a set of parameterized business rules to prevent the check amount increase from exceeding the amount of the previous cleared check with a ratio 302. In a sequence of promissory notes, the increase by an extra-proportional factor is an indicator of a transaction anomaly related to stressful behavior. The third part of the behavior validation is the velocity limits 303, which uses a discrete probability distribution that expresses the probability of a number of events occurring in a fixed interval of time and/or space if these events occur with a rate based on historical data and independent of the time since the last event, and to determine whether the Promissory Payment Transaction (PPT) event is occurring independently of previous PPT for the given time interval. A shorter interval is an indication of an anomaly related to stressful behavior of the merchant's client. Each industry may use a customized version of this distribution. Velocity is defined herein as the time elapsed between the last submitted transaction of the check writer and the amount of the current transaction used to measure behavior under stress. The system validates velocity rules 303 that define how many checks may be issued within a defined time interval. These steps 301, 302 and 303 use the details delivered by the merchant's promissory note and complete the behavior aspects of the validation of the transaction. Information 401 based on behavior aspects will be given to the operator 402 on the terminal running the API 152.

Confirming messages 401, the operator 402 decides on further processing. Following the inspection of the behavior of the writer, the system initiates the authentication processing. The first authentication is performed on the address 501. It further tracks the real IP number 502 to detect fraud simultaneously or consecutively using more than one route to submit a transaction with the aim to overdraw the account. The state of origin of the transaction is checked 503 and validated to comply to State specific regulatory acts. The submitting device is detected at 504.

Next a set of scrubbing routines 505 is used with third-parties to perform verification, validation, and authentication of the provided data information on the promissory note such as the bank account number, ABA routing number, account balance, negative check writer records.

Decision 601 will route the transaction to either a rejected status or to the next group of validation routines 701, 702 and 703 depending on the result of the address validation 501, IP-Tracking 502, Geo-blocking 503 or the causing device determined in 504 and verifications mentioned in 505. At this stage the submitter of the transaction is found to be authentic and the behavior was not found to be exceptional. In the next step, the system performs a rating 701 and if out of bounds, it will be screened by an operator 702 on the transaction details. And as final step 703, the system verifies the provided communication endpoints: email address, telephone number, social security number, date of birth.

In decision 801 is decided either to accept or reject the transaction. Rating 701, manual screening during the clearing process 702 or checks on communication endpoints 703, routes the transaction to either rejected or accepted status.

The acceptance 901 administrates further processing for cleared transactions. The rejection 902 administrates further processing for rejected transactions. Once the behavior, authentication, and rating verifications have passed, the transaction is passed to the destination to authorize the withdrawal from the writer's Demand Deposit Accounts (DDA) 952.

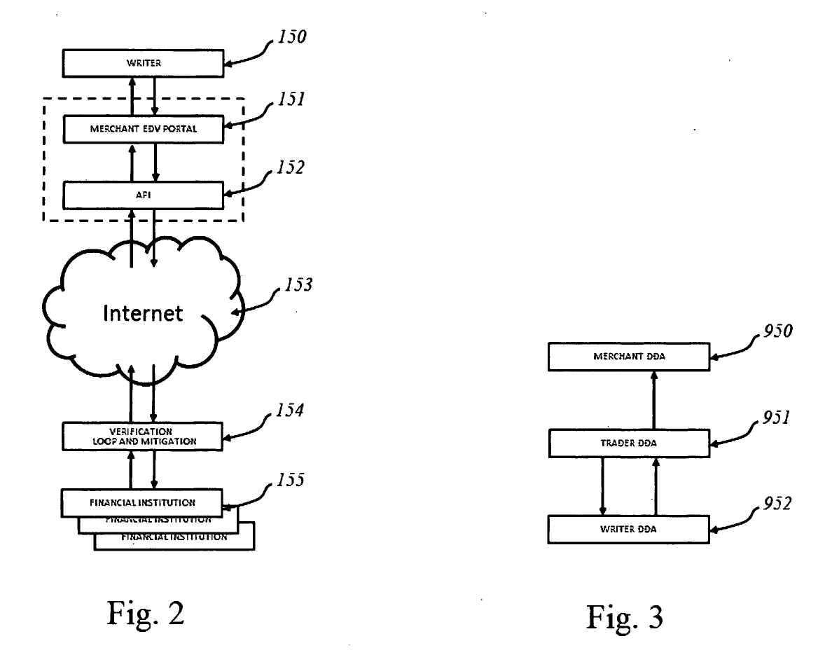

FIG. 2 is a diagram that illustrates the real-time check processing system where the writer or customer 150 issues a promissory note using the internet portal 151 of the merchant. Internet portal 151 commits the promissory note using API (Application Program Interface) 152 over internet 153 using a secured protocol to backbone system infrastructure 154. The backbone 154 performs an array of validations, returns a message to API 152, and if so required, settles the transaction with the financial institutions 155. The financial institution 155 returns a confirmation or rejection message.

FIG. 3 displays an accounting perspective on how PPT are transferred. Financial institutions transfer the PPT from the writers DDA 952 to the trader DDA 951. Within a defined period of time, and dependent on the kind of PPT, the financial institution may reverse the PPT from the traders bank DDA 951 back to the writer DDA 952 for any reason. This process is called a ‘return’ and is risk to the trader as soon as the merchant was paid. This is the reason for a service provider to make the best possible clearance decision before submitting the transaction to the merchant's DDA 950. The addition to add a behavioral test to this trader clearance reduces the risk exposure and reputation of the trader significantly.

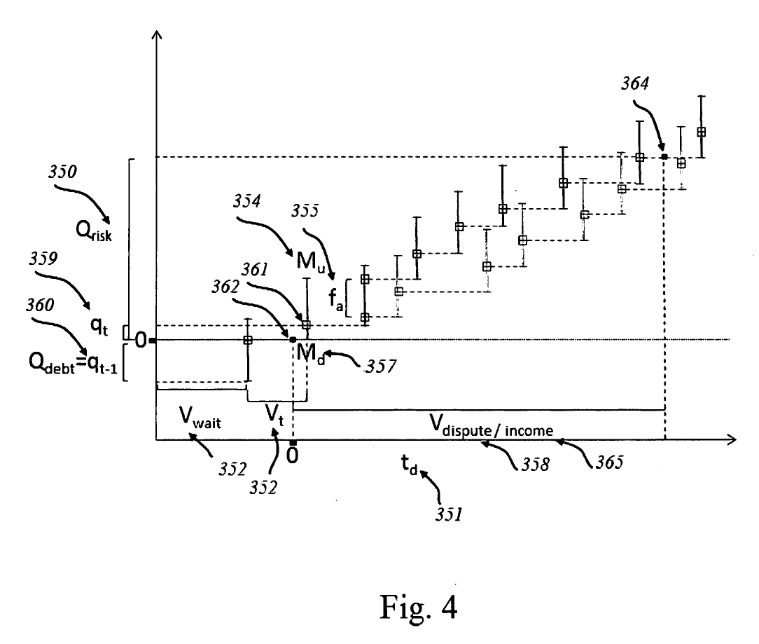

In FIG. 4, the model to process promissory payment transaction (PPT) with the risk to default for real-time transactions using aspects of human survival behavior under stressful life situations is illustrated. The Vertical axis represents the debt of a customer (e.g. the risk height of the amount of debt equals the height of the risk). On the horizontal axis 351 we have the velocity of PPT measuring the time t_{d} passed. V_{wait} 352 is set on the condition that the writer is new to the system. This factor 352 is used to support the identification and therefore the abuse of multiple registrations by the same writer. The elapsed time from the submission of a PPT is defined by Vₜ 352. The first submitted check would be at V₁, the second at V₂, the third on V₃ and so forth. During a period of V_{dispute} 358 the bank of the writer of the PPT has the right to return the transaction causing a debt Q_{debt} 350 on the service providers DDA. The dispute velocity V_{dispute} 358 may vary between typically thirty days and a year and depends on the financial institution that manages the DDA. The more time that passes from the submission of a PPT the longer V_{dispute} 358 and the higher the risk Qᵣᵢₛₖ 350, which crosses the lines at the level of outstanding debt 364. The monthly income cycle V_{income} 356 is taken into consideration and will reduce the risk monthly. Any PPT has an upper limit Mᵤ 354 and lower limit M_{d} 356. These limits are dependent on the writer of the PPT. As long as the submission of PPT occur independently of the time passed since the last event it is considered to be normal behavior. The velocity is measured by a Poisson distribution. The maximum increase amount fₐ 355 is initially set at a factor fₐ, meaning that the writer may issue a PPT with an amount fₐ higher than the previous PPT. Typically fₐ 355 depends on the field of business.

The industry and merchants specific fₐ's are a result from analyzing historical transaction data. The fₐ 355 is restricted by the upper limit Mᵤ 354 and lower limit M_{d.} 356. The height of the previous PPT may not allow the quadrupling of the amount. Qₜ 359 is the amount of risk at time t. Qₜ₋₁ 360 illustrates the debt caused by a returned transaction at t=0.

The DDA amount 361 is within the allowed upper limit 354 and lower limit 356 at a given time. Point 362 represents time 0. Financial transactions made before this time 0 that have been cleared represent a risk for a contractually defined period of dispute.

Any and all other obvious modifications to one or more of the parts of this invention are inherently incorporated herein.

What is claimed is:

1. A method of executing computer executable instructions by one or more processors with the purpose to forecast whether a promissory payment will default by a check writer, said method comprising the steps of:
a. receiving information about a financial transaction;
b. maintaining and creating historical information about said financial transaction;
c. evaluating the velocity of reoccurrences of said transaction;
d. using a preformed model to evaluate upper and lower risk limits of said promissory payment, determine delays between a first registration and a first transaction, set limits to the number of bank accounts, identify discrepancies between transaction data and any available external reference data that can be used in secondary phases to support identified transaction anomalies; and
e. providing an indication to a merchant whether or not to decline said promissory payment.

2. The method of claim 1, wherein said information in step a. includes information about said promissory payment; information identifying the individual proffering the promissory payment; and information about the field of business of said check writer.

3. The method of claim 1, wherein said information in step b. includes the identity of the individual proffering the promissory payment and information about the field of business of said check writer;

4. The method of claim 1, wherein the evaluating of the velocity of reoccurrences in step c. uses a discrete probability distribution calculation that expresses the probability of a number of transactions occurring in a fixed interval of time that occur with a rate based on merchant and industry specific historical data and independent of the time in between transactions; and taking into account an income cycle of said check writer and a return cycle of the chosen financial institution.

5. A verification and mitigation system for accepting or rejecting promissory notes from a check writer comprising the steps of:
a. determining whether said check writer is new to said system;
b. using a set behavioral standards and patterns to determine whether said check writer and said promissory notes are at a higher than normal risk level;
c. using a set of predetermined business rules to determine whether any one of said promissory notes does not comply with said rules;
d. using a set of velocity limits to determine whether any number of said promissory notes are being submitted outside of a predetermined range of acceptable frequency;
e. authenticating said check writer by authenticating the device said check writer is using to submit said promissory notes;
f. determining a rating for said check writer by using the information gathered from steps a. through e.
g. using said rating to determine whether or not to accept any one of said promissory notes.

6. The system of claim 5, wherein when within step a. said check writer is determined to be new to said system, a wait period is initiated before proceeding to step b.

7. The system of claim 5, wherein when within step b. it is determine that said check writer and said promissory notes are at a higher than normal risk level, any one of said promissory notes can be denied.

8. The system of claim 5, wherein when within step c. it is determined that any one of said promissory notes does not comply with said rules, any one of said promissory notes can be denied.

9. The system of claim 5, wherein when within step d. it is determined that any one of said promissory notes being submitted is outside of said predetermined range of acceptable frequency, any one of said promissory notes can be denied.

10. The system of claim 5, wherein within step e. authenticating the device of said check writer includes tracking and verifying the IP addresses thereof.

11. The system of claim 5, wherein within step e. further authenticating said check writer by verifying their bank account numbers, ABA routing numbers, account balances, and previous check writing records.

12. The system of claim 5, wherein within step e. further authenticating said check writer by verifying their email address, telephone number, social security number, and date of birth.

13. The system of claim 5, wherein within step f. said rating also being based upon data obtained by using promissory note frequency data versus predetermined risk factors accumulated by said check writer from a history of previous check submissions by said check writer.

14. The system of claim 5, further including step
g. wherein when any one of said promissory notes is rejected, said promissory note is reversed and returned to said check writer.
